(19) United States
(12) Patent Application Publication
(10) Pub. No.: US 2026/0188564 A1
(43) Pub. Date: Jul. 2, 2026

(54) WINDING MEMBER WITH CONNECTION PART

(71) Applicant: Aplus Power Technology (Hangzhou) Co., Ltd., Hangzhou (CN)

(72) Inventors: Tianding HONG, Hangzhou (CN); Feng YAO, Hangzhou (CN)

(21) Appl. No.: 19/434,552

(22) Filed: Dec. 29, 2025

(30) Foreign Application Priority Data
Dec. 31, 2024 (CN) 202411996362.0
Dec. 31, 2024 (CN) 202423320092.X

(51) Int. Cl. H01F 27/29; H01F 27/22; H01F 27/24

(52) U.S. Cl. CPC H01F 27/29; H01F 27/22; H01F 27/24

(57) ABSTRACT

A winding member, including: connection parts; and two conductive sheets arranged opposite each other, where each conductive sheets includes main bodies and a pin, each main body includes a first end and a second end, the first end is connected to the connection part and the second end is connected to the pin, an accommodating space is defined by the connection part and the main body of each conductive sheet opposite each other, where in a mounting direction of the winding member, a height difference between the second end and the connection part is greater than or equal to zero, a total number of the connection parts is same as a total number of the main bodies of each conductive sheet, and the total number of the connection parts is N, and where N is a positive integer.

### CROSS-REFERENCE TO RELATED APPLICATION

This application claims priority to and the benefit of Chinese Patent Application No. 202411996362.0, filed on Dec. 31, 2024 and Chinese Patent Application No. 202423320092.X, filed on Dec. 31, 2024, the disclosure of which is incorporated herein by reference in its entirety.

### TECHNICAL FIELD

The present disclosure relates to electrical technologies, and in an embodiment, to a winding member with a connection part.

### BACKGROUND

In a transformer with a secondary winding for outputting a greater output current, a stamped copper sheet is generally used as the secondary winding to enhance current-carrying capacity. Referring to FIGS. 1 and 2, since the copper sheet A is formed by planar stamping, connecting two turns of copper sheets A in series is generally achieved through wirings on the printed circuit board (PCB) of the transformer. For example, each copper sheet A is formed with two pin ends, i.e., a first connection end a1 and a second connection end a2, respectively, and each of the first connection end a1 and the second connection end a2 is configured to be welded together with a PCB board. When it is necessary to connect two turns of the copper sheets A in series, the first connection end a1 of one of the copper sheets A and the second connection end a2 of the other one of the copper sheets A are connected by the PCB, as shown by a dashed line in FIG. 2. This not only adds unnecessary solder joints, but also increases the complexity of the wiring design of the PCB.

To this end, the related art provides a vertical winding solution using flat wires. For example, referring to FIG. 3, a secondary winding B includes a plurality of copper sheets A (each layer of copper sheet A is equivalent to a turn of a coil), adjacent ones of the copper sheets A are connected in series from end to end, and only first and last layers of copper pieces A are provided with a first connection end a1 and a second connection end a2, so that only the first connection end a1 and the second connection end a2 need to be welded together with a PCB board, so that not only the number of the solder joints can be reduced, but also the complexity of the wiring design of the PCB can be reduced.

However, there is a significant drawback to the vertical winding solution using flat wires. Referring to FIGS. 3 and 4, there is no space between the coils of the secondary winding B to place a primary winding C. The primary winding C can only be arranged at a side of the secondary winding B, and the magnetic field intensity is relatively stronger in a region where the primary winding C and the secondary winding B are close to each other. From Ampère's circuital law

$$H = \frac{N \cdot I}{I} ,$$

it can be seen that the magnetic field intensity is

$$\frac{2 I}{l}$$

at the region where the primary winding C and the secondary winding B are close to each other. The greater the magnetic field intensity, the greater the generated eddy current loss, which is disadvantageous to the efficiency of the transformer.

### SUMMARY

Embodiments of the present disclosure provide a winding member, a magnetic assembly, and a power supply to at least solve the above technical problems.

In a first aspect of the present disclosure, an embodiment of the present disclosure provides a winding member including one or more connection parts and two conductive sheets arranged opposite each other, where each of the conductive sheets includes one or more main bodies and a pin, each of the one or more main bodies includes a first end and a second end, the first end is connected to the connection part and the second end is connected to the pin, an accommodating space is defined by the connection part and the main body of each of the conductive sheets opposite each other; in a mounting direction of the winding member, a height difference between the second end and the connection part is greater than or equal to zero, a total number of the one or more connection parts is same as a total number of the one or more main bodies of each of the conductive sheets, and the total number of the one or more connection parts is N, and where N is a positive integer.

In some embodiments, the connection part includes a first connection part and a second connection part, the first end of the main body is connected to the second connection part through the first connection part, and a height difference between the second end of the main body and the second connection part is greater than or equal to zero in the mounting direction of the winding member.

In some embodiments, the pin includes one or more first pins and one or more second pins, a total number of the one or more first pins is two, and a total number of the one or more second pins is N−1, and where the second pin is formed by connecting the pin connected to the second end of each of the one or more main body and the pin connected to the second end of other one of the one or more main body adjacent to the each of the one or more main body.

In some embodiments, N=1, each of the one or more first pins are connected to the second end of each of two ones of the one or more main bodies of each of the conductive sheets and the one or more first pins are located at both sides of the connection part, respectively, and a current flowing through one of the one or more main bodies has a same direction as a current flowing through other one of the one or more main bodies.

In some embodiments, N≥2, for two adjacent main bodies of the one or more main bodies of each of the conductive sheets, a current flowing through one of the two adjacent main bodies has an opposite direction with a current flowing through other one of the two adjacent main bodies, and where for two main bodies respectively at the two conductive sheets and opposite to each other, a current flowing through one of the two main bodies has a same direction as a current flowing through other one of the two main bodies.

In some embodiments, the second pin is disposed between the one or more first pins, one of the one or more first pins and one of the second one or more pins adjacent to the one of the first pins are located at different ones of the conductive sheets, respectively, and adjacent two ones of the one or more second pins are located at different ones of the conductive sheets, respectively.

In some embodiments, the one or more main bodies are respectively provided with one or more mounting through-holes, and the mounting through-holes of two of the one or more main bodies opposite each other are aligned with each other to form an accommodating channel, the one or more main bodies are respectively further provided with one or more gaps, the mounting through-holes are respectively in communication with the gaps, and the pin and one of the connection parts are respectively located at both sides of the gap.

In some embodiments, the one or more connection parts and the two conductive sheets are integrally formed through a stamping-bending-integrated forming process.

In some embodiments, the pin is provided with a heat concentration hole and/or a heat concentration groove.

According to a second aspect of the present disclosure, an embodiment of the present disclosure provides a magnetic assembly including a winding and two magnetic cores opposite each other, the winding includes a first winding and a second winding, where the first winding is the winding member as described above, and the second winding is located in the accommodating space; each of the magnetic cores includes a cover plate, a winding post and a common post, where both an end of the winding post and an end of the common post are connected to the cover plate, the winding post is arranged within an accommodating channel, the accommodating channel is formed by two mounting through-holes penetrating through two of the main bodies opposite to each other and respectively disposed at different ones of the two conductive sheets, and the mounting through-holes, the accommodating channel and the winding post are aligned each other, and where the number of the winding posts is N and the number of the common posts is greater than or equal to zero.

In some embodiments, the first winding is a primary winding, the second winding is a secondary winding, and the secondary winding has a disk coil structure; or, the first winding is the secondary winding, the second winding is the primary winding, and the primary winding has the disk coil structure.

In some embodiments, the side wall of the cover plate is provided with a heat dissipation groove penetrating through the cover plate in a thickness direction of the cover plate.

According to a third aspect of the present disclosure, an embodiment of the present disclosure provides a power supply including a circuit board and a magnetic assembly as described above, and the magnetic assembly is in communication with the circuit board through the pin.

### BRIEF DESCRIPTION OF THE DRAWINGS

For a more complete understanding of the present disclosure and its advantages, reference will now be made to the following description taken in conjunction with the accompanying drawings, in which same reference numerals designate refers to elements in the following description.

FIG. 1 is a perspective view of a copper sheet in the prior art.

FIG. 2 is a schematic perspective view of a copper sheet in the prior art.

FIG. 3 is a perspective view of a primary winding and a secondary winding in the prior art.

FIG. 4 is a diagram showing a change in magnetic field intensity when a primary winding and a secondary winding in FIG. 3 are assembled.

FIG. 5 is a perspective view of a winding according to an embodiment of the present disclosure.

FIG. 6 is a perspective view of a winding member according to an embodiment of the present disclosure.

FIG. 7 is a schematic view of a winding member shown in FIG. 6 in an expanded state.

FIG. 8 is a schematic top view of a winding member shown in FIG. 6.

FIG. 9 is a schematic front view of a winding member shown in FIG. 6.

FIG. 10 is a schematic front view of a winding member according to another embodiment of the present disclosure.

FIG. 11 is a perspective view of a winding member shown in FIG. 10.

FIG. 12 is a schematic view of a winding member shown in FIG. 10 in an expanded state.

FIG. 13 is a schematic front view of a winding member according to still another embodiment of the present disclosure.

FIG. 14 is a perspective view of a winding member shown in FIG. 13.

FIG. 15 is a schematic view of a winding member shown in FIG. 13 in an expanded state.

FIG. 16 is a perspective view of a magnetic assembly according to an embodiment of the present disclosure.

FIG. 17 is an exploded view of a magnetic assembly shown in FIG. 16.

FIG. 18 is a diagram showing a change in magnetic field intensity when a primary winding and a secondary winding of a magnetic assembly shown in FIG. 16 are assembled.

FIG. 19 is a perspective view of a magnetic assembly according to another embodiment of the present disclosure.

FIG. 20 is a perspective view of a magnetic assembly according to still another embodiment of the present disclosure.

FIG. 21 is an exploded view of a magnetic assembly shown in FIG. 20.

FIG. 22 is a schematic top view of a magnetic assembly shown in FIG. 20.

FIG. 23 is a schematic top view of a magnetic assembly according to yet another embodiment of the present disclosure.

FIG. 24 is a perspective view of a power supply according to an embodiment of the present disclosure.

FIG. 25 is a perspective view of a power supply according to another embodiment of the present disclosure.

FIG. 26 is a perspective view of a power supply according to still another embodiment of the present disclosure.

### DETAILED DESCRIPTION

Technical solutions in embodiments of the present disclosure will be clearly and completely described below in conjunction with drawings in the embodiments of the present disclosure. Apparently, the described embodiments are only a part of embodiments of the present disclosure, rather than all the embodiments. Based on the embodiments in the present disclosure, all other embodiments obtained by those skilled in the art without creative work fall within the protection scope of the present disclosure.

In order to facilitate an understanding of the solution of the present disclosure, the spline curves and arrows used for the reference numerals in the accompanying drawings will be described as follows: the components indicated by the spline curves without arrows are solid components are components with physical structures. The components indicated by the spline curve with arrows are virtual components are components without the physical structures.

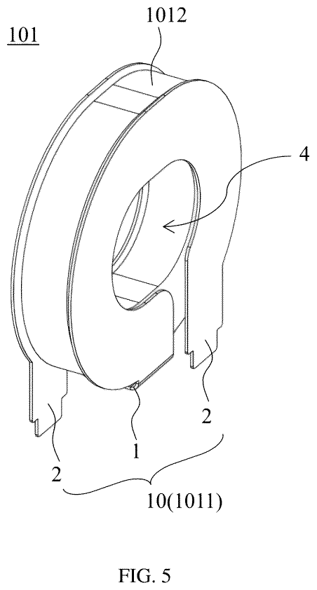

In a first aspect, referring to FIGS. 5 to 24, an embodiment of the present disclosure provides a winding member 10 applied in a magnetic assembly 100 including, but not limited to, at least one of a transformer, an inductor, and the like.

In an embodiment, the winding member 10 includes a connection part 1 and two conductive sheets 2 arranged opposite each other. The conductive sheet 2 includes a main body 21 and a pin 22. The main body 21 includes a first end 211 and a second end 212. The first end 211 is connected to the connection part 1. The second end 212 is connected to the pin 22. An accommodating space 3 is defined by the connection part 1 and the main body 21 of each of the conductive sheets opposite each other. Here, a height difference between the second end 212 and the connection part 1 in a height direction of the main body 21 is greater than or equal to zero. The total number of the connection parts 1 is same as the total number of the main bodies 21 of each conductive sheet 2, and the total number is both N, where N is a positive integer.

The winding member 10 includes the connection part 1 to which the two conductive sheets 2 are connected, and the two conductive sheets 2. In an example, the connection part 1 and the two conductive sheets 2 may be integrally formed, or the connection part 1 may be welded together with the two conductive sheets 2.

The two conductive sheets 2 are arranged opposite each other. For example, the two conductive sheets 2 are arranged face-to-face and spaced apart from each other. It will be appreciated that the connection part 1 and the conductive sheet 2 are located in different planes, respectively. As an example, the two conductive sheets 2 are parallel to each other, and the connection part 1 is perpendicular to the conductive sheets 2.

For example, one of the conductive sheets 2 may be referred to as a first conductive sheet and the other of the conductive sheets 2 may be referred to as a second conductive sheet. A side surface of the first conductive sheet faces the second conductive sheet, and likewise, a side surface of the second conductive sheet faces the first conductive sheet. However, the first and second conductive sheets are not in direct contact with each other. Instead, the first conductive sheet and the second conductive sheet are indirectly connected via the connection part 1, so that a current may flow from the first conductive sheet to the second conductive sheet through the connection part 1.

The term “conductive sheet” refers to an electrically conductive member in the form of a sheet. As an example, the conductive sheet 2 is a metal sheet, such as a copper sheet.

Each conductive sheet 2 includes a main body 21 and a pin 22. It should be noted that each conductive sheet 2 may have one or more main bodies 21 and one or more pins 22.

In an embodiment, the total number of connection parts 1 is same as the total number of main bodies 21 of each conductive sheet 2, and both the total numbers may be N, where N is a positive integer. For example, when each conductive sheet 2 has one main body 21, there is only one connection part 1 connecting the two main bodies 21. When each conductive sheet 2 has two main bodies 21, there are two connection parts 1, one of the two connection parts 1 connects two of the main bodies 21, and the other of the two connection parts 1 connects the remaining two main bodies 21.

The main body 21 includes a first end 211 connected to the connection part 1 and a second end 212 connected to the pin 22, that is, the connection part 1 and the pin 22 are respectively connected to both ends of the main body 21, and the main body 21 is connected between the connection part 1 and the pin 22. Thus, the current flow path in the winding member 10 is: the connection part 1—the main body 21—the pin 22. The current may flow from the connection part 1 to the pin 22 through the main body 21, or the current may flow from the pin 22 to the connection part 1 through the main body 21.

It should be noted that since the connection part 1 and the pin 22 are respectively connected to different ends of the main body 21, the pin 22 is spaced apart from the connection part 1, that is, the pin 22 is not directly connected to the connection part 1. This avoids direct current flow between the pin 22 and the connection part 1.

To more clearly illustrate the relationship between the pin 22 and the connection part 1, the pin 22 of the first conductive sheet may be referred to as a left pin and the pin 22 of the second conductive sheet may be referred to as a right pin. In the winding member 10, the pins 22 are spaced apart from the connection part 1. For example, the left pin, the right pin, and the connection part 1 are spaced apart from each other. That is, the left pin and the right pin are spaced apart from each other, the left pin and the connection part 1 are spaced apart from each other, and the right pin and the connection part 1 are spaced apart from each other.

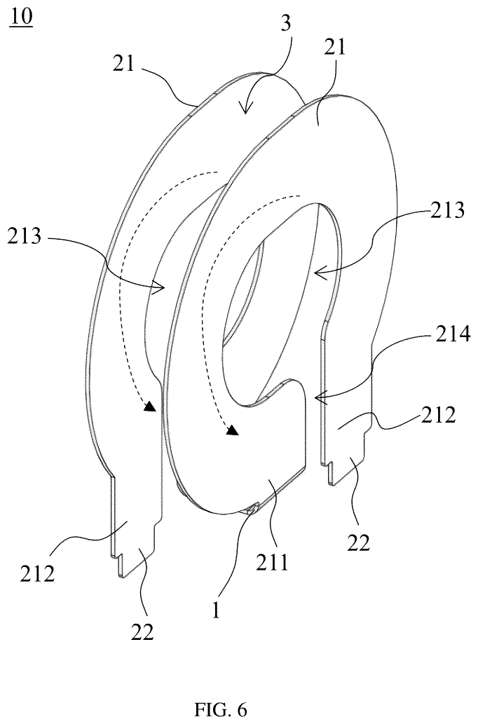

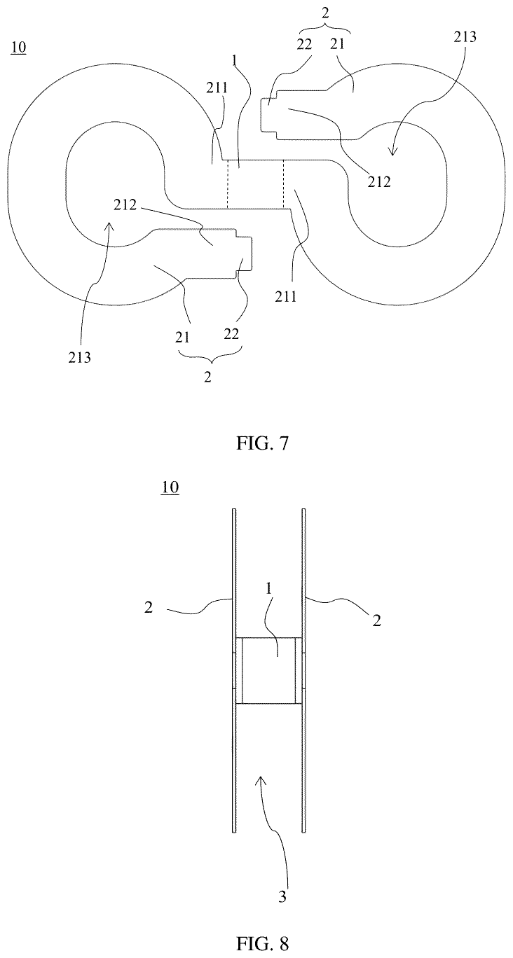

Alternatively, the pins 22 of the different conductive sheets 2 are separated by the connection part 1. That is, the pins 22 to which the two opposite main bodies 21 are connected are respectively provided on both sides/ends of the connection part 1 for connecting the two opposite main bodies 21, rather than on the same side/end of the connection part 1. As an example, referring to FIG. 7, the left pin is located on one side of the connection part 1, and the right pin is located on the other side of the connection part 1. Therefore, in the winding member 10, the direction of the current flowing through the first main body is same as the direction of the current flowing through the second main body. For example, the direction may be the clockwise direction as shown by the dashed lines with arrows in FIG. 6.

Since the two conductive sheets 2 are arranged opposite each other, the main bodies 21 of the two opposite conductive sheets 2 are arranged opposite each other. In this way, the two opposite main bodies 21 of the different conductive sheets 2 and the connection part 1 connecting the two opposite main bodies 21 may together define the accommodating space 3.

In an example, the main body 21 of the first conductive sheet is referred to as the first main body, and the main body 21 of the second conductive sheet is referred to as the second main body. The first main body and the second main body are opposite to each other, and both the first main body and the second main body are connected to the connection part 1. The first main body, the second main body and the connection part 1 together define the accommodating space 3.

In an example, the winding member 10 is a secondary winding, and the accommodating space 3 is used for accommodating a primary winding. The connection part 1 may support the primary winding, and the two main bodies 21 may limit the primary winding from both sides of the primary winding. In other examples, the winding member 10 may be the primary winding, so that the accommodating space 3 is used for accommodating the secondary winding.

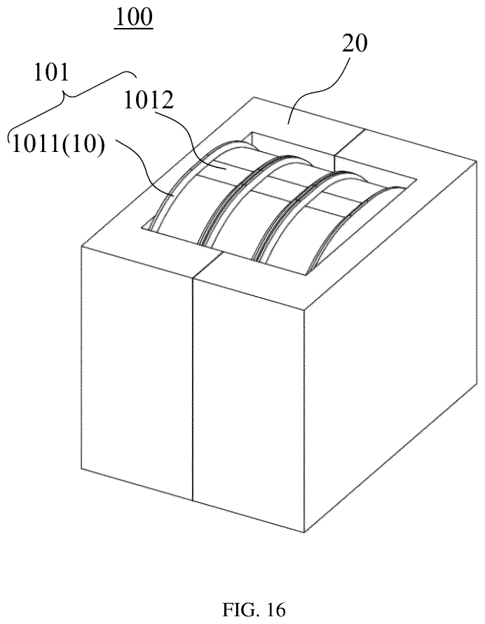

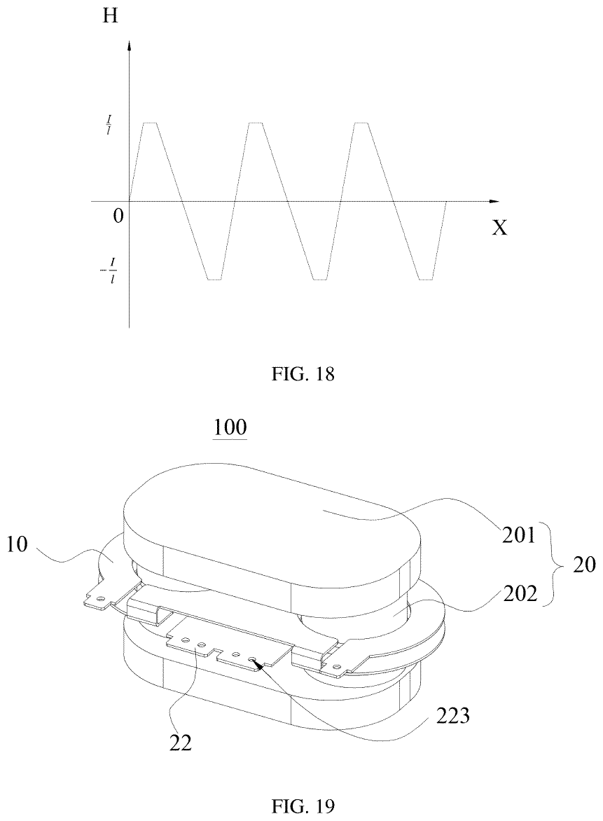

Referring to FIG. 5, FIG. 6, FIG. 16, and FIG. 18, the winding member 10 is the secondary winding, and the accommodating space 3 is used for accommodating the primary winding. Under the condition that the primary winding is loaded within the accommodating space 3, the magnetic field intensity H at a spatial position corresponding to one of the secondary windings is increased from zero to.

$$\frac{I}{l} .$$

In this case, the current in the primary winding flows in the opposite direction to that in the secondary winding, thus, due to the current in the primary winding flowing in the opposite direction to that in the secondary winding, the magnetic field intensity H at the spatial position corresponding to the primary winding decreases from to

$$\frac{I}{l} to - \frac{I}{l} ,$$

while the magnetic field intensity H at the spatial position corresponding to the other of the secondary windings increases again from

$$- \frac{I}{l}$$

to zero. Since the current in the primary winding flows in the opposite direction to that in the secondary winding, the magnetic field intensity H at the primary winding decreases, which is reflected in the decreasing negative slope. There is no current at the air position, so that the magnetic field intensity thereof remains unchanged.

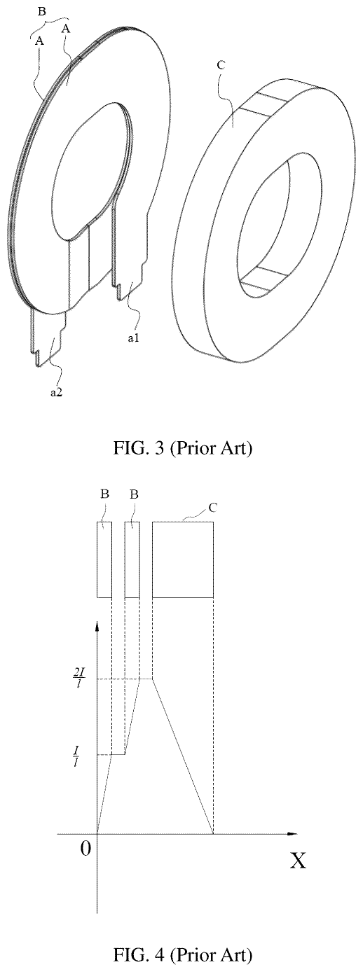

It can be seen that, since there is the accommodating space 3 between the two conductive sheets 2, the accommodating space 3 is used for accommodating the primary winding. When the primary winding is accommodated within the accommodating space 3, the magnetic field intensity of the position where the primary winding and the secondary winding are close to each other is half as compared with that of the flat wire winding (see FIGS. 3 and 4), resulting in a corresponding reduction in losses.

With continued reference to FIG. 5, FIG. 6, FIG. 16 and FIG. 18, the winding member 10 includes the connection part 1 and the two opposite conductive sheets 2, each conductive sheet 2 including the main body 21, such that the winding member 10 is configured to include two continuous turns of coils by using one of the conductive sheets 2 to connect to the other of the conductive sheets 2. Each main body 21 corresponds to a turn of the coil, and the connection part 1 connects the two main bodies 21, thereby enabling connection of the two turns of the coil in series.

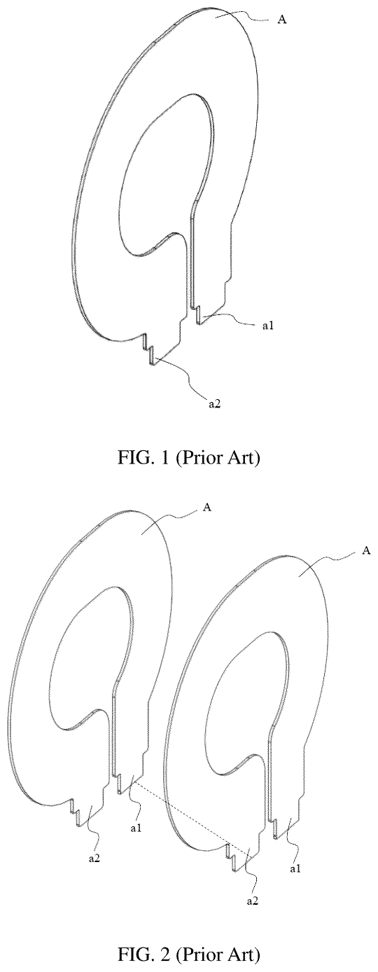

As can be seen, compared to the configuration where the conductive sheets 2 are arranged separately (see FIGS. 1 and 2), the total number of the pins 22 required for the winding member 10 including two conductive sheets 2 is reduced from four to two, and the number of the pins 22 is significantly reduced. That is, in an embodiment of the present invention, since the main bodies 21 of the different conductive sheets 2 may be connected via the connection part 1, each main body 21 may only require one pin 22 to achieve an effective electrical connection with the circuit board 200.

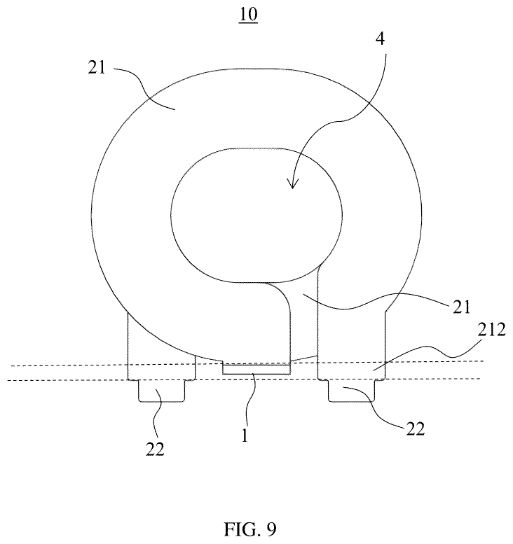

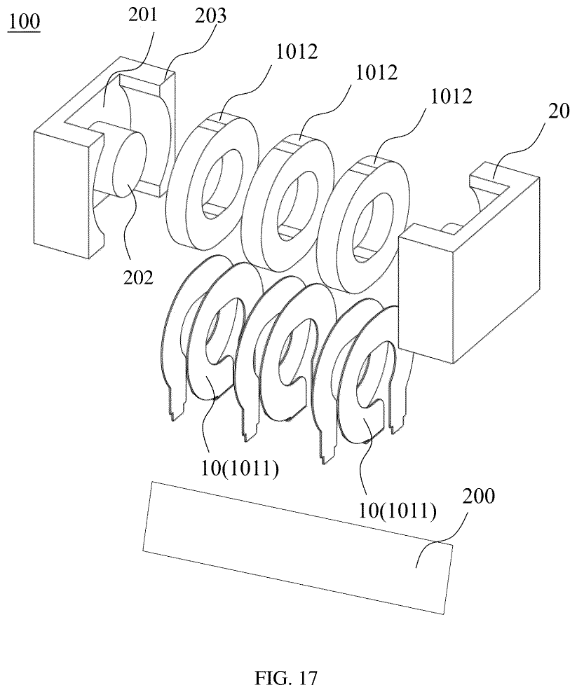

Further, in the mounting direction (a vertical direction) of the winding member 10, the height difference between the second end 212 and the connection part 1 is greater than or equal to zero, as shown in FIG. 9, so that in the mounting direction of the winding member 10, the height difference between the pin 22 connected to the second end 212 and the connection part 1 is also greater than zero. That is, the pin 22 protrudes from the side surface of the connection part 1 away from the accommodating space 3. Referring to FIG. 17, the mounting direction of the winding member 10 refers to the direction in which the winding member 10 is mounted to the circuit board 200.

Generally, the connection between the pin 22 and the main body 21 refers to that an end of the pin 22 is connected to the main body 21, and the other end of the pin 22 is formed as a free end. The free end of the pin 22 extends away from the main body 21 and protrudes from the side surface of the connection part 1 away from the accommodating space 3.

In an example, in the winding member 10, a dashed line connecting the free end of the left pin to the free end of the right pin (see the dashed line in FIG. 9) is located at a side of the connection part 1 away from the accommodating space 3. That is, the distance between the dashed line connecting the free end of the left pin to the free end of the right pin and the side surface of the connection part 1 away from the accommodating space 3 is greater than zero.

The pin 22 is used as an electrical connection terminal of the winding member 10 for connection to the circuit board 200, so that the winding member 10 is electrically connected to the circuit board 200. In an example, the pins 22 may be inserted into conductive holes (e.g., plated through-holes PTH, etc.) provided in the circuit board 200 and soldered together with the hole walls of the conductive vias by solder. Since the free end of the pin 22 protrudes from the side surface of the connection part 1 away from the accommodating space 3, when the pin 22 is connected to the circuit board 200, interference caused by the connection part 1 may be reduced, thereby reducing the difficulty in connecting the pin 22 to the circuit board 200.

In summary, the winding member 10 according to an embodiment of the present disclosure has the following advantages.

First, the accommodating space 3 is between the connection part 1 and the opposite main body 21. When the winding member 10 is used as one of the primary winding and the secondary winding, and the other of the primary winding and the secondary winding is provided within the accommodating space 3, the magnetic field intensity at the position where the primary winding and the secondary winding are close to each other may be significantly reduced, thereby reducing the loss.

Next, in the winding member 10, since the main bodies 21 of the different conductive sheets 2 may be connected via the connection part 1, each main body 21 may be effectively electrically connected to the circuit board 200 by using only a corresponding one of the pins 22, so that not only the number of solder joints may be reduced, but also the design difficulty in the wirings of the circuit board 200 may be reduced.

Again, since the free end of the pin 22 protrudes from the side surface of the connection part 1 away from the accommodating space 3, the accommodating space 3 and the connection part 1 are raised in the height, so that when the pin 22 is connected to the circuit board 200, the risk of interference between the connection part 1 and the circuit board 200 may be reduced, thereby increasing the operation space in which the pin 22 is connected to the circuit board 200, and reducing the difficulty in connecting the pin 22 to the circuit board 200.

In some embodiments, referring to FIG. 11, the connection part 1 includes a first connection part 11 and a second connection part 12, and the first end 211 of the main body 21 is connected to the second connection part 12 through the first connection part 11. The height difference between the second end 212 of the main body 21 and the second connection part 12 is greater than or equal to zero in the mounting direction of the winding member 10.

It will be appreciated that the first connection part 11 is located between the first end 211 of the main body 21 and the second connection part 12. The second end 212 of the main body 21 is spaced apart from the second connection part 12. In the mounting direction of the winding member 10, the height difference between the second end 212 and the connection part 1 is greater than or equal to zero, or the height difference between the second end 212 and the second connection part 12 is greater than or equal to zero.

Compared with the first connection part 11, the second connection part 12 is farther from the main body 21. By controlling the height difference between the second end 212 of the main body 21 and the second connection part 12, the risk of interference between the connection part 1 and the circuit board 200 is further reduced.

Since the connection part 1 and the conductive sheet 2 are not located in the same plane, at least one of the first connection part 11 and the second connection part 12 has a curved structure.

In an example, the first connection part 11 has a curved structure, and the main body 21 is indirectly connected to the second connection part 12 through the first connection part 11. In this case, the second connection part 12 may have a planar structure, or may have the curved structure.

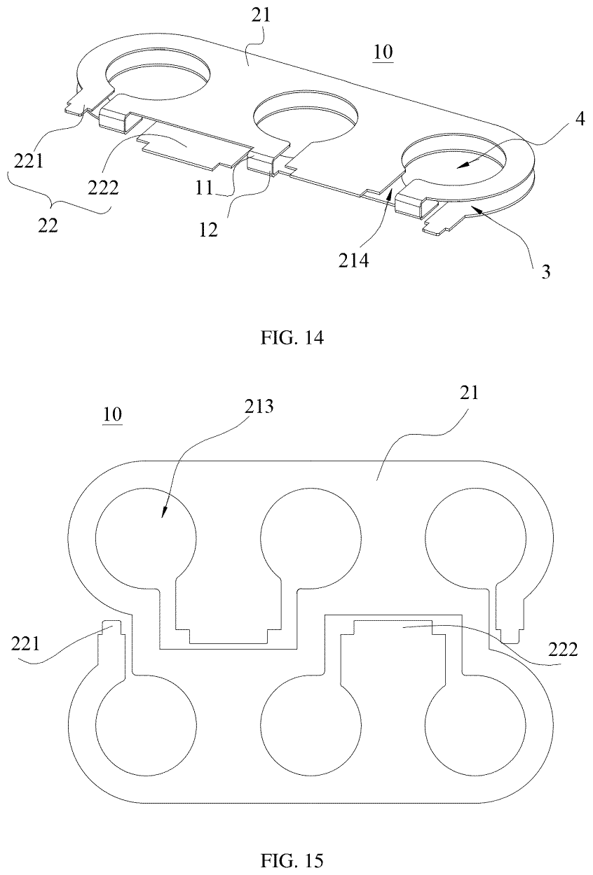

In some embodiments, referring to FIG. 14, the pin 22 includes a first pin 221 and a second pin 222, the total number of the first pins 221 is two, and the total number of second pins 222 is N−1. The second pin 222 is formed by connecting the pins, adjacent to each other, of two adjacent main bodies of the same conductive sheet into a single unit.

The first pin 221 and the second pin 222 are different types of pins 22. The first pin 221 is also referred to herein as a separate pin 22, and each first pin 221 is connected to only a corresponding one of the main body 21. The second pin 222, also referred to as the common pin 22, is connected to both two adjacent ones of the main bodies 21 of the same conductive sheet 2. The second pin 222 is a pin 22 common to the two adjacent ones of the main bodies 21. In the winding member 10, each main body 21 is connected to only a corresponding one of the pins 22, so that the second pin 222 is formed by connecting two adjacent first pins 221 into a single unit. Alternatively, the second pin 222 is formed by edge-to-edge connection of two adjacent ones of the first pins 221, such that the surface area of the second pin 222 is equal to the sum of the surface areas of the two first pins 221, i.e., twice the surface area of a single first pin 221.

It will be appreciated that the number of the first pins 221 in the winding member 10 is two, and the number of the second pins 222 in the winding member 10 is N−1. Then the total number of the first pins 221 and the second pins 222 (also referred to as the total number of the pins) is N+1. The

number of the second pins 222 is related to the number N of the main bodies 21 of the conductive sheet 2. There may be no second pin 222 in the winding member 10, or there may be one or more second pins 222. The number of the second pins 222 may be less than the number of the first pins 221, and may be equal to the number of the first pins 221, or may be greater than the number of the first pins 221.

It can be seen that when N is greater than or equal to 2, the number of the second pins 222 is greater than or equal to one, and the number of the pins 22 may be further reduced by providing the second pins 222, thereby reducing the number of the solder joints and the difficulty in installing the winding member 10. Furthermore, the arrangement of the second pin 222 may realize equipotential design and further reduce the design difficulty of the wirings of the circuit board 200.

In an example, referring to FIG. 6, when the number of the main bodies 21 of a single conductive sheet 2 is one, the total number of the first and second pins 221 and 222 of the winding member 10 is two, both being the first pins 221. The two first pins 221 are respectively provided on two different conductive sheets 2.

In an example, referring to FIG. 11, when the number of the main bodies 21 of each of the two conductive sheets 2 is two, the total number of the first and second pins 221 and 222 on the winding member 10 is three, where two first pins 221 of the three pins are provided at a same one of the conductive sheets 2 and one second pin 222 of the three pins is provided at the other one of the conductive sheets 2.

As an example, referring to FIG. 14, when the number of the main bodies 21 of each of the two conductive sheets 2 is three, the total number of the first and second pins 221 and 222 of the winding member 10 is four, where two pins 22 of the four pins are the first pins 221, two pins 22 of the four pins are the second pins 222, and each conductive sheet 2 is provided with one first pin 221 and one second pin 222.

According to the same rule, under the condition that the number of the main bodies 21 of each of the two conductive sheets 2 is six, the total number of the first and second pins 221 and 222 of the winding member 10 is seven, where one of the conductive sheets 2 is provided with two first pins 221 and two second pins 222, and the other one of the conductive sheets 2 is provided with three second pins 222.

Referring to FIGS. 2 and 6, for the solution shown in FIG. 2, since the conductive sheets 2 (such as copper sheets) are provided separately from each other, the total number of pins 22 required for a winding 101 including the two conductive sheets 2 is 4N, where N=1. That is, the total number of the pins 22 is four. In the winding member 10 of the present disclosure, only (N+1) pins 22 are required, where N=1. That is, the total number of the pins 22 is two. It can be seen that the number of the pins 22 is significantly reduced, compared to the related art. Similarly, in the case that N=2, for the configuration with separately arranged conductive sheets 2, the total number of the pins 22 is eight. However, for the solution provided in an embodiment of the present application with N=2, the total number of the pins 22 is three. Thus the number of the pins 22 is significantly reduced, compared to the related art. The greater N is, the more pronounced the reduction in the number of the pins 22 is for the solution provided by an embodiment of the present disclosure.

In some embodiments, referring to FIG. 6, N=1, the two first pins 221 are respectively connected to the second ends 212 of the two main bodies 21 and are located at both sides of the connection part 1. The two main bodies 21 are configured such that the current flowing through one of the main bodies 21 has the same direction as the current flowing through the other of the main bodies 21.

That is, in the case where current is applied to the winding member 10, the current flowing through one of the main bodies 21 has the same direction as the current flowing through the other of the main bodies 21.

The winding member 10 is used to cooperate with the magnetic core 20. The winding column 202 on the magnetic core 20 is used to pass through the main body 21, that is, the main body 21 is sleeved on the winding column 202, so that the winding member 10 may be effectively engaged with the magnetic core 20 by controlling the current flowing through one of the main bodies 21 to have the same direction as the current flowing through the other of the main bodies 21.

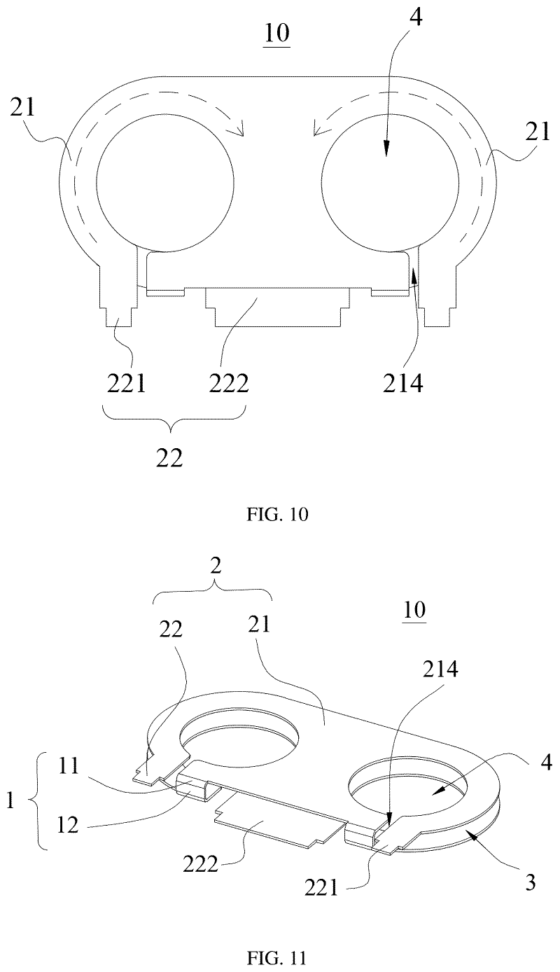

In some embodiments, referring to FIGS. 10 and 13, N≥2, for two adjacent ones of the main bodies 21 of each of the two conductive sheets 2, the current flowing through one of the two adjacent main bodies 21 has the opposite direction with (is antiparallel with) the current flowing through the other of the two adjacent main bodies 21. For two main bodies 21 respectively at the two conductive sheets 2 and opposite to each other, the current flowing through one of the two main bodies 21 has the same direction as the current flowing through the other of the two main bodies 21.

That is, in the case where the winding member 10 is supplied with current, the current flows in the two adjacent main bodies 21 of each conductive sheet 2 have the opposite flow directions, and the current flows in the two opposite main bodies 21 of the different conductive sheets 2 have the same flow direction.

With the above arrangement, since N is greater than or equal to two, that is, the number of the main bodies 21 of each of the two conductive sheets 2 is more than one. A plurality of different main bodies 21 may be integrally formed at the same conductive sheet 2, so that at least portions of the positions of two adjacent ones of the main bodies 21 of each conductive sheet 2 that are at equal potential may be connected together, thereby reducing the risk of short-circuit. In addition, the total area of the main bodies 21 of the conductive sheet 2 may be increased, that is, the amount of the conductive components is increased, and the conductive performance is improved, thereby improving the power of the winding member 10 (i.e., magnetic device).

In an example, referring to FIG. 10, there are two main bodies 21 at each of the conductive sheets 2, and two different current flow paths are formed at each conductive sheet 2 as shown by dashed lines with arrows in FIG. 10.

In an example, referring to FIG. 13, there are three main bodies 21 at each conductive sheet 2, and three different current flow paths are formed at each conductive sheet 2.

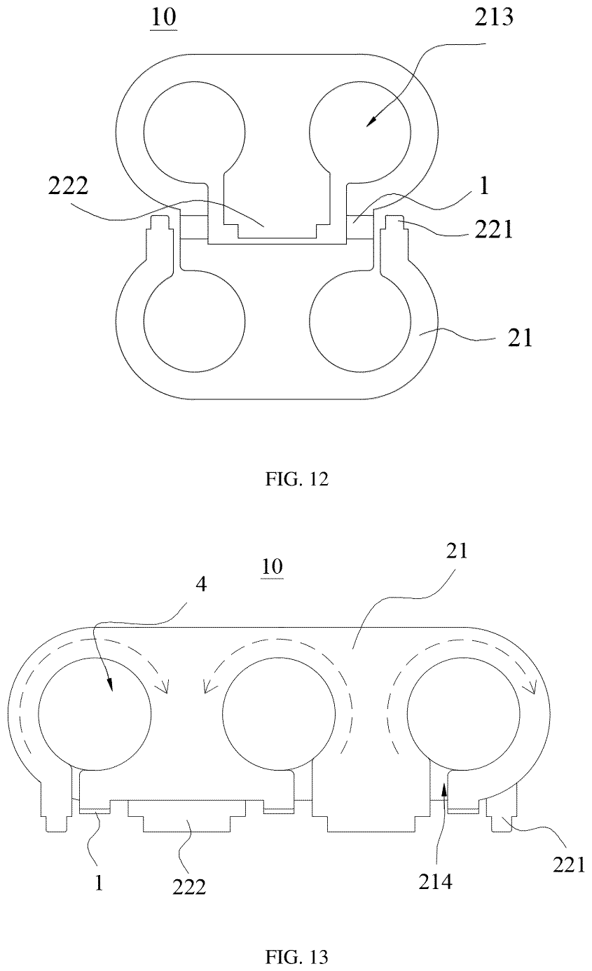

In some embodiments, referring to FIGS. 12 and 15, the second pin 222 is disposed between the first pins 221, one of the first pins 221 and one

of second pins 222 adjacent to the one of the first pins 221 are located at different ones of the two conductive sheets 2, respectively, and adjacent two ones of the second pins 222 are located at different ones of the two conductive sheets 2, respectively.

When the number N of the main bodies 21 of each conductive sheet 2 is an even number, two first pins 221 are located at the same conductive sheet 2, so that the total number of the pins 22 including the pins 221 and 222 is an odd number. In this case, the number of the pins 22 at one of the two conductive sheets 2 is not same as the number of the pins 22 at the other of the two conductive sheets 2. The number of the pins 22 at one of the conductive sheets 2 provided with the two first pins 221 is one more than the number of the pins 22 at the other of the conductive sheets 2. When N is an odd number, the two first pins 221 are respectively located at different conductive sheets 2, so that the total number of the pins 22 (including the pins 221 and 222) of the conductive sheets 2 is an even number. In this case, the number of the pins 22 at one of the conductive sheets 2 provided with the two first pins 221 is same as the number of the pins 22 at the other of the conductive sheets 2.

In some embodiments, referring to FIG. 6, FIG. 7, FIG. 11, FIG. 12, FIG. 14, and FIG. 15, the main body 21 is provided with a mounting through-hole 213, and the mounting through-holes 213 of the two main bodies 21 opposite each other are aligned with each other to collectively form the accommodating channel 4. A gap 214 is further provided at the main body 21, and the mounting through-hole 213 is in communication with the gap 214, and the pin 22 and the connection part 1 are located at both sides of the gap 214, respectively.

The main body 21 is further provided with a mounting through-hole 213, and the mounting through-holes 213 of the two main bodies 21 opposite each other correspond to each other and together form the accommodating channel 4. The accommodating channel 4 is configured to allow the winding post 202 of the magnetic core 20 to pass through, so that the winding member 10 is sleeved on the winding post 202 of the magnetic core 20.

It will be appreciated that the winding post 202 of the magnetic core 20 will pass through the mounting through-hole 213. The shape of the mounting through-hole 213 may be set according to the cross-sectional shape of the winding post 202 so that the winding post 202 may fit appropriately with the mounting through-hole 213. In an example, the shape of the mounting through-hole 213 may be at least one of a circle, an ellipse, a runway shape, a square, and a rectangle. It should be noted that each main body 21 is provided with one mounting through-hole 213, but each conductive sheet 2 may be provided with a plurality of main bodies 21, so that the number of the mounting through-holes 213 at each conductive sheet 2 may be one or more. When the number of the mounting through-holes 213 at each conductive sheet 2 is more than one, the mounting through-holes 213 may be arranged spaced apart from each other, to form the plurality of accommodation channels 4, so that the winding member 10 may be assembled with the magnetic core 20 having the plurality of winding posts 202, thereby increasing the power density of the obtained magnetic assembly 100.

To more clearly illustrate the formation of the accommodating channel 4, the mounting through-hole 213 at the first conductive sheet may be referred to as the first mounting through-hole 213, the mounting through-hole 213 at the second conductive sheet may be referred to as the second mounting through-hole 213, and the first mounting through-hole 213 and the second mounting through-hole 213 are in one-to-one correspondence when the first conductive sheet and the second conductive sheet are disposed opposite each other.

In order to realize the one-to-one arrangement of the mounting through-holes 213 at the two conductive sheets 2, the number of the mounting through-holes 213 at one of the conductive sheets 2 may be same as the number of the mounting through-holes 213 at the other of the conductive sheets 2, and the position of the mounting through-holes 213 at one of the conductive sheets 2 may correspond to the position of the mounting through-holes 213 at the other of the conductive sheets 2. However, the shapes of the mounting through-holes 213 at the two conductive sheets 2 may be same as each other or different from each other, and similarly, and the areas of the mounting through-holes 213 at the two conductive sheets 2 may be same as each other or different from each other. When the areas and the shapes of the mounting through-holes 213 at the two conductive sheets 2 may be same as each other, the resulting accommodating channel 4 may be a straight channel. When the shapes of the mounting through-holes 213 at the two conductive sheets 2 may be same as each other, but the areas of them are different, the resulting accommodating channel 4 may be a tapered channel.

In an example, the first conductive sheet is provided with two first mounting through-holes 213, and the second conductive sheet is provided with two second mounting through-holes 213. One of the first mounting through-holes 213 at the first conductive sheet corresponds to one of the first mounting through-holes 213 at the second conductive sheet to form one of the accommodating channels 4. The other of the first mounting through-holes 213 at the first conductive sheet corresponds to the other of the first mounting through-holes 213 at the second conductive sheet to form the other of the accommodating channels 4.

The main body 21 is further formed with the gap 214 and the gap 214 communicates the mounting through-hole 213 with the outside, where the outside refers to the environment outside the conductive sheet 2. The pin 22 and the connection part 1 are located at both sides of the gap 214, respectively. That is, the gap 214 may separate the pin 22 from the connection part 1. In an example, the pin 22 and the connection part 1 of the main body 21 are provided spaced apart from each other, a first sub-gap is formed between the pin 22 and the connection part 1, a second sub-gap is further hollowed out at the main body 21, and the first sub-gap communicates with the second sub-gap. The second sub-gap communicates with the mounting through-hole 213. That is, the gap 214 includes the first sub-gap and the second sub-gap, and the mounting through-hole 213 may communicate with the outside through the gap 214.

The gap 214 is used to prevent the pin 22 from being directly connected to the connection part 1, thereby avoiding direct current flow between the pin 22 and the connection part 1.

In some embodiments, referring to FIGS. 6, 7, 11, 12, 14, and 15, the connection part 1 and the two opposing conductive sheets 2 are integrally formed through a stamping-bending-integrated forming process.

In an embodiment, the sheet-shaped conductor is stamped and integrally formed to obtain the winding member 10 in the expanded state. Then, the winding member 10 in the folded state may be obtained by bending the winding member 10 in the expanded state. In this case, the winding member 10 in the folded state may be directly used as the first winding group 101.

The winding member 10 obtained through the above method has a high strength, allowing it to also serve as a frame. Thus, when the winding member 10 is applied to a magnetic assembly 100, an additional frame may be omitted, which is helpful for increasing the power density of the magnetic assembly 100 and improving the heat dissipation performance of the magnetic assembly 100. In addition, the stamping-bending-integrated forming process is simpler, thereby facilitating the manufacturing feasibility of the winding member 10.

In some embodiments, referring to FIG. 19, the pin 22 is provided with a heat concentration hole 223 and/or a heat concentration groove.

Both grooving and digging may reduce the conductive material of the pin 22, and the conductive material generally has thermal conductivity, thereby deteriorating the thermal conductivity of the pin 22, so that heat tends to accumulate more easily on the pin 22, thereby making soldering easier and improving the effect of soldering the pin 22 to the circuit board 200.

In a second aspect, referring to FIGS. 16 to 23, an embodiment of the present disclosure further provides a magnetic assembly 100 including a winding 101 and two magnetic cores 20 opposite each other. The winding 101 includes one or more first windings 1011 and one or more second windings 1012. The first winding 1011 is the winding member 10 as described above, and the second winding 1012 is located within the accommodating space 3. The magnetic core 20 includes the cover plate 201, the winding post 202, and the common post 203. Both an end of the winding post 202 and an end of the common post 203 are connected to the cover plate 201. The winding post 202 is disposed within the accommodating channel 4. The accommodating channel 4 is formed by the mounting through-holes 213 penetrating through two main bodies 21, opposite to each other and respectively disposed at different ones of the two conductive sheets 2. The mounting through-holes 213, the accommodating channel 4, and the winding post 202 are aligned with each other. Here, the number of the winding posts 202 is N, and the number of the common posts 203 is greater than or equal to zero.

The winding 101 serves as a circuit part in the magnetic assembly 100, and the winding 101 includes the first winding 1011 and the second winding 1012 cooperating with each other. One of the first winding 1011 and the second winding 1012 is the primary winding and the other of the first winding 1011 and the second winding 1012 is the secondary winding. The magnetic assembly 100 is used as the transformer for example. If the transformer is used for boosting, that is, the transformer is applicable to a low voltage-high voltage application scenario, the first winding 1011 may be used as the primary winding and the second winding 1012 may be used as the secondary winding. If the transformer is used for step-down, i.e., the transformer is suitable for a high voltage-low voltage application scenario, the first winding 1011 may be used as the secondary winding and the second winding 1012 may be used as the primary winding.

The magnetic core 20 serves as the magnetic circuit portion of the magnetic assembly 100. The number of the magnetic cores 20 is two, and the two magnetic cores 20 are arranged opposite to each other so that a closed magnetic circuit may be formed.

In an embodiment, the magnetic core 20 includes the cover plate 201, the winding post 202, and the common post 203. An end of the winding post 202 and an end of the common post 203 are connected to the cover plate 201. The number of the winding posts 202 is N, and the number of the common post 203 is greater than or equal to zero.

The mounting through-holes 213, the accommodating channel 4, and the winding post 202 correspond to each other, the winding post 202 extends through the accommodating channel 4, and the main body 21 is sleeved on the winding post 202. Thus, the number of the winding posts 202 in the magnetic core 20 is same as the number of the accommodating channels 4 in the winding member 10, and the number of the accommodating channels 4 is same as the number N of the main bodies 21 in each conductive sheet 2, and the number of the winding posts 202 is N.

In an example, when the number of the accommodating channels 4 is one, only one winding post 202 may be provided on the cover plate 201. When the number of the accommodating channels 4 is more than one, more than one winding posts 202 may be provided at the cover plate 201. If the number of the accommodating channels 4 is more than one, and the number of the winding posts 202 is more than one, the winding posts 202 correspond one-to-one with the accommodation channels 4 and are spaced apart from each other, thereby providing accommodation space for the winding member 10 and facilitating its assembly.

The number of common posts 203 is greater than or equal to zero, that is, the magnetic core 20 may or may not include the common post 203.

In an embodiment, the magnetic core 20 includes a plurality of common posts 203 spaced apart from each other and disposed at the cover plate 201. The common post 203 is spaced apart from the winding post 202. The common posts 203 are located substantially at an edge region of the cover plate 201 and the winding post 202 is located substantially at a center region of the cover plate 201. By providing the plurality of common posts 203, the number of closed magnetic circuits may be further increased to enrich the design type of the magnetic assembly 100. In addition, the winding post 202 is located substantially at a center region of the cover plate 201 to facilitate engagement of the winding post 202 with the accommodating channel 4, and the common post 203 is located substantially at an edge region of the cover plate 201 so that the winding member 10 is located inside the common post 203, thereby enabling the common post 203 to limit or protect the winding member 10.

In an example, referring to FIG. 21, two winding posts 202 and four common posts 203 spaced apart from each other are provided on each cover plate 201. Thus, when two magnetic cores 20 are arranged opposite each other, at least five closed magnetic circuits can be formed.

According to a second aspect of the present disclosure, the magnetic assembly 100 includes the winding member 10 described above, and the magnetic assembly 100 has all the beneficial effects of the winding member 10, and details are not described herein.

In some embodiments, referring to FIG. 16, the first winding 1011 is the primary winding, the second winding 1012 is the secondary winding, and the secondary winding has a disk coil structure. Alternatively, the first winding 1011 is the secondary winding, the second winding 1012 is the primary winding, and the primary winding 1012 has the disk coil structure.

The second winding 1012 is set to have the disk coil structure, to increase winding layers, and to increase the number of coil turns. In an example, the disk coil structure includes a plurality of strands of twisted wires or a plurality of strands of twisted wires with an insulating layer.

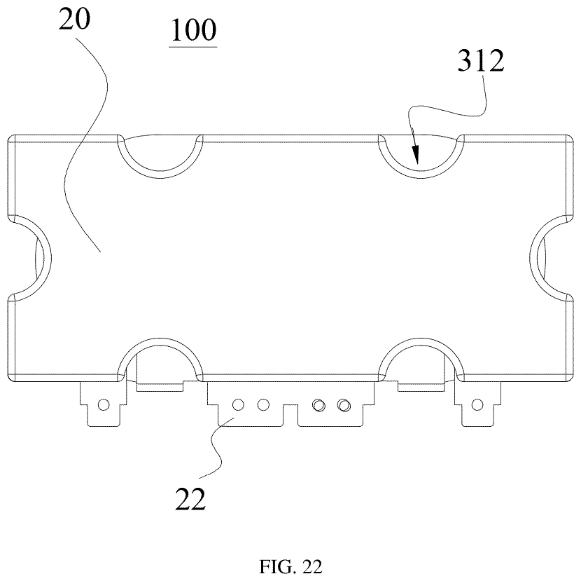

In some embodiments, referring to FIG. 22, a heat dissipation groove 312 penetrating through the cover plate 201 is provided on a side wall of the cover plate 201.

Because the magnetic field intensity at the edge region of the cover plate 201 is weaker, the heat dissipation groove 312 is formed in the side wall of the cover plate 201 by recessing the side wall of the cover plate 201, so that the weight of the cover plate 201 may be reduced. The heat dissipation groove 312 penetrates through the cover plate 201, to facilitate heat dissipation for the magnetic assembly 100 due to the heat dissipation groove 312.

The number of the heat dissipation grooves 312 on the cover plate 201 may be one or more.

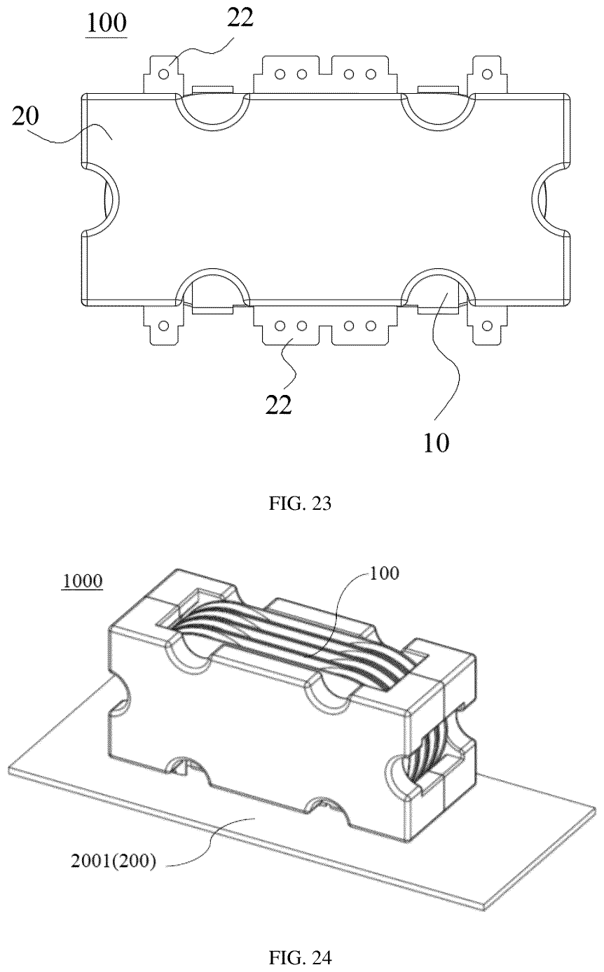

In some embodiments, referring to FIG. 23, the position of at least a portion of the heat dissipation grooves 312 corresponds to the position of the connection part 1 in the winding member 10. The connection part 1 is used for conducting current, and the connection part 1 is generally relatively narrower, so that the connection part 1 is easy to heat. By aligning the position of the heat dissipation grooves 312 with that of the connection part 1, heat dissipation for the connection portion 1 is facilitated.

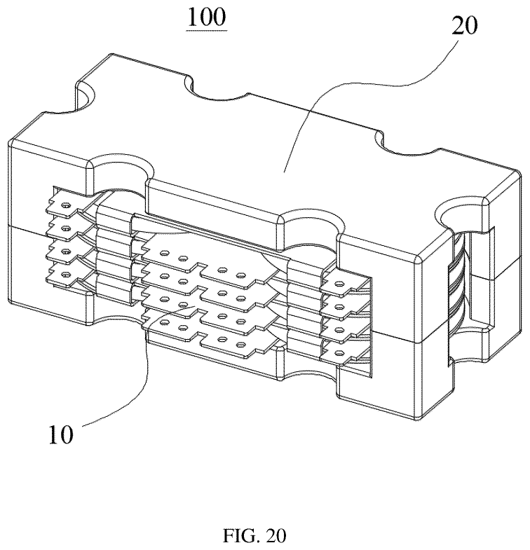

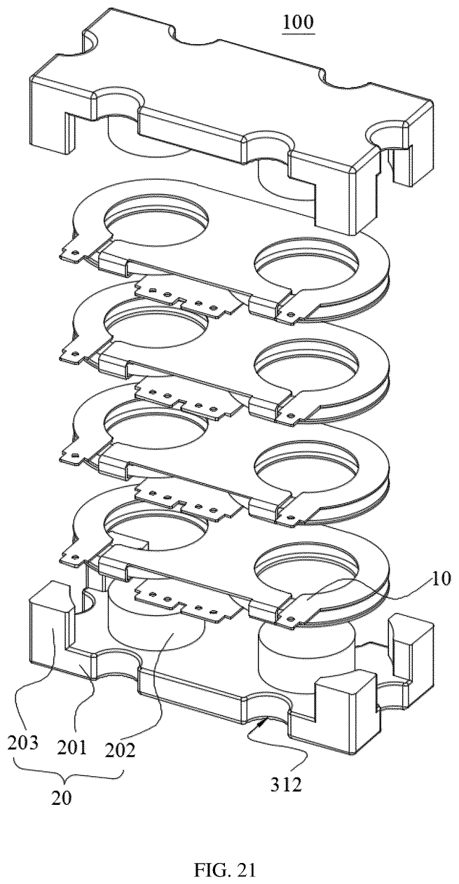

In some embodiments, referring to FIGS. 16 and 20, the magnetic assembly 100 includes a plurality of winding members 10 arranged in a stacked manner. That is, the number of the winding members 10 in the magnetic assembly 100 is more than one. By increasing the number of the winding members 10 and stacking all of the winding members 10 between the two magnetic cores 20, the energy density of the magnetic assembly 100 may be further increased.

In an example, referring to FIG. 16, the magnetic assembly 100 includes three winding members 10 arranged in a stacked manner such that the magnetic field intensity H in the magnetic assembly 100 undergoes three cycles, consistently maintaining a lower magnetic field intensity, thereby resulting in lower losses for the magnetic assembly 100.

It should be emphasized here that the number of magnetic assemblies 100 may be set according to actual power requirements so that the magnetic assemblies 100 are more flexible and adaptable to applications with different power levels.

In some embodiments, referring to FIGS. 22 and 23, the pins 22 of the winding member 10 protrude from/beyond the edges of the cover plate 201, and the edges of the main body 21 do not protrude from/beyond the edges of the cover plate 201.

Therefore, not only the connection of the pins 22 to the circuit board 200 is facilitated, but also the circuit portion and the magnetic circuit portion of the magnetic assembly 100 may be better coordinated, and the cover plate 201 may protect the main body 21.

In some embodiments, referring to FIG. 22, the cover plate 201 has the first and second side edges opposite each other. The pins 22 of all the winding members 10 protrude beyond the first side edge, the number of the circuit boards 200 is one. The circuit board 200 is disposed adjacent to the first side edge. Thus, the pins 22 of all the winding members 10 are connected to the same circuit board 200, and the structure of the magnetic assembly 100 is more compact.

In some embodiments, referring to FIG. 23, the cover plate 201 has the first and second side edges opposite each other, with a portion of the pins 22 of the winding member 10 projecting beyond the first side edge and other portion of the pins 22 of the winding member 10 projecting beyond the second side edge. The number of the circuit boards 200 is two, with one circuit board 200 disposed adjacent to the first side edge and the other circuit board 200 disposed adjacent to the second side edge. This has the advantage of facilitating the connection of the pins 22 to the circuit boards 200, while the configuration of the wirings inside each circuit board 200 is simpler.

In some embodiments, the magnetic assembly 100 includes at least one of a transformer and an inductor.

In a third aspect, referring to FIGS. 24 to 26, an embodiment of the present disclosure further provides a power supply 1000 including the circuit board 200 and the magnetic assembly 100 as described above. The magnetic assembly 100 is electrically connected to the circuit board 200 via the pin 22.

Referring to FIGS. 17 and 24, the pin 22 is connected to the circuit board 200 so that electrical connection in the circuity in winding member 10 may be controlled by the circuit board 200.

In some embodiments, referring to FIG. 24, the circuit board 200 includes a first circuit board 2001. The magnetic assembly 100 is disposed on the first circuit board 2001. The pins 22 of the magnetic assembly 100 are each oriented toward and connected to the first circuit board 2001. In an example, the pins 22 of all the winding members 10 protrude from the same side of the cover plate 201, and the pins 22 are plugged onto the first circuit board 2001.

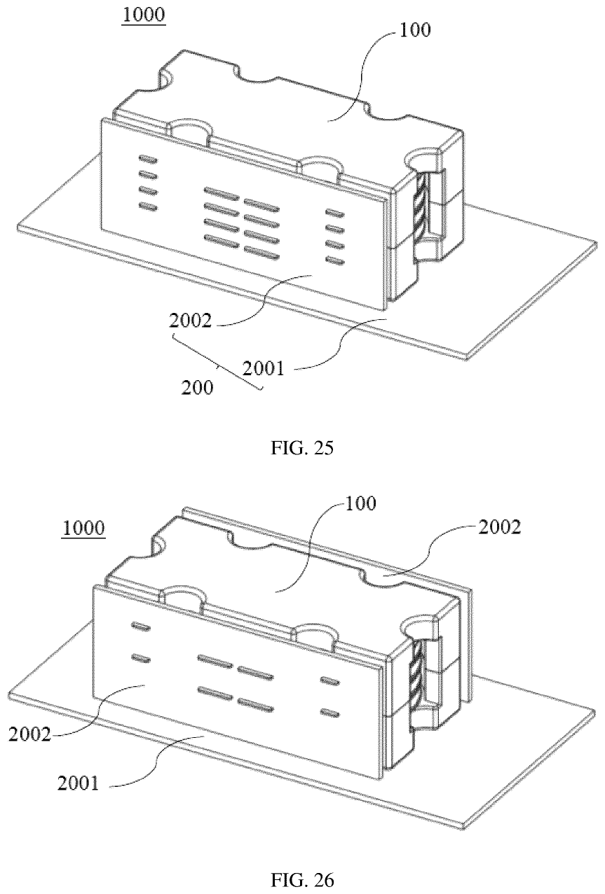

In some embodiments, referring to FIGS. 25 and 26, the circuit board 200 includes a first circuit board 2001 and a second circuit board 2002. The second circuit board 2002 is disposed vertically on and electrically connected to the first circuit board 2001. The magnetic assembly 100 is disposed on the first circuit board 2001. The side edge of the magnetic assembly 100 is close to the second circuit board 2002. In an embodiment, the magnetic assembly 100 includes the magnetic core 20. The cover plate 201 of the magnetic core 20 is supported on the first circuit board 2001, and the second circuit board 2002 is adjacent to the common post 203 of the magnetic core 20 and the side of the cover plate 201. The pin 22 of the winding member 10 protrudes from the cover plate 201 and are connected to the second circuit board 2002. In an example, the first circuit board 2001 is a main circuit board, and the second circuit board 2002 is a sub-circuit board or a synchronous rectifier board.

In some embodiments, referring to FIG. 25, the number of second circuit boards 2002 is one, and the pins 22 of all the winding members 10 protrude from the same side of the cover plate 201 and are connected to the second circuit board 2002.

In some embodiments, referring to FIG. 26, the number of second circuit boards 2002 is two. Two second circuit boards 2002 are respectively disposed at opposite sides of the magnetic assembly 100. For the magnetic assembly 100, a portion of the pins 22 of the winding member 10 protrude from a side edge of the cover plate 201 and is connected to one of the second circuit boards 2002, and the other portion of the pins 22 of the winding member 10 protrude from the other side edge of the cover plate 201 and is connected to the other of the second circuit boards 2002.

According to a third aspect of the present disclosure, the power supply 1000 includes the above-described magnetic assembly 100, and the power supply 1000 has all the advantages of the above-described magnetic assembly 100, and details are not described herein.

In some embodiments, the switching power supply 1000 includes a charger. In an example, the charger is an in-vehicle charger.

In the description of the present disclosure, the terms “first” and “second” are used for descriptive purposes only and are not to be construed as indicating or implying relative importance or implicitly specifying the number of the indicated technical features. Thus, features defined by “first” and “second” may explicitly or implicitly include one or more such features. In the description of the present disclosure, “a plurality of” means two or more, unless explicitly stated otherwise.

In the above-mentioned embodiments, the description of each embodiment has its own emphasis, and parts not described in detail in a certain embodiment may be referred to the related description of other embodiments.

The embodiments, implementations, and related technical features of the present disclosure may be combined and replaced with each other without conflict.

The above provides merely some embodiments of the present disclosure, and is not intended to impose any formal limitations thereon the present disclosure. However, any simple modifications, equivalent variations, and adaptations made to the above embodiments in accordance with the technical essence of the present disclosure, without departing from the contents of the technical solution of the present disclosure, shall fall within the scope of the technical solution of the present disclosure.

What is claimed is:

1. A winding member, comprising:
one or more connection parts; and
two conductive sheets arranged opposite each other, wherein each of the conductive sheets comprises one or more main bodies and a pin, each of the one or more main bodies comprises a first end and a second end, the first end is connected to the connection part and the second end is connected to the pin, an accommodating space is defined by the connection part and the main body of each of the conductive sheets opposite each other,
wherein in a mounting direction of the winding member, a height difference between the second end and the connection part is greater than or equal to zero, a total number of the one or more connection parts is same as a total number of the one or more main bodies of each of the conductive sheets, and the total number of the one or more connection parts is N, and wherein N is a positive integer.

2. The winding member according to claim 1, wherein the connection part comprises a first connection part and a second connection part, the first end of the main body is connected to the second connection part through the first connection part, and a height difference between the second end of the main body and the second connection part is greater than or equal to zero in the mounting direction of the winding member.

3. The winding member according to claim 1, wherein the pin comprises one or more first pins and one or more second pins, a total number of the one or more first pins is two, and a total number of the one or more second pins is N−1, and wherein the second pin is formed by connecting the pin connected to the second end of each of the one or more main body and the pin connected to the second end of other one of the one or more main body adjacent to the each of the one or more main body.

4. The winding member according to claim 3, wherein N=1, each of the one or more first pins are connected to the second end of each of two ones of the one or more main bodies of each of the conductive sheets and the one or more first pins are located at both sides of the connection part, respectively, and a current flowing through one of the one or more main bodies has a same direction as a current flowing through other one of the one or more main bodies.

5. The winding member according to claim 3, wherein N≥2, for two adjacent main bodies of the one or more main bodies of each of the conductive sheets, a current flowing through one of the two adjacent main bodies has an opposite direction with a current flowing through other one of the two adjacent main bodies, and wherein for two main bodies respectively at the two conductive sheets and opposite to each other, a current flowing through one of the two main bodies has a same direction as a current flowing through other one of the two main bodies.

6. The winding member according to claim 5, wherein the second pin is disposed between the one or more first pins, one of the one or more first pins and one of the second one or more pins adjacent to the one of the first pins are located at different ones of the conductive sheets, respectively, and adjacent two ones of the one or more second pins are located at different ones of the conductive sheets, respectively.

7. The winding member according to claim 4, wherein the one or more main bodies are respectively provided with one or more mounting through-holes, and the mounting through-holes of two of the one or more main bodies opposite each other are aligned with each other to form an accommodating channel, the one or more main bodies are respectively further provided with one or more gaps, the mounting through-holes are respectively in communication with the gaps, and the pin and one of the connection parts are respectively located at both sides of the gap.

8. The winding member according to claim 7, wherein the one or more connection parts and the two conductive sheets are integrally formed through a stamping-bending-integrated forming process.

9. The winding member according to claim 8, wherein the pin is provided with a heat concentration hole and/or a heat concentration groove.

10. A magnetic assembly, comprising:
a winding, comprising a first winding and a second winding, wherein the first winding is a winding member, and the second winding is located in the accommodating space, and wherein the winding member comprises:
one or more connection parts; and
two conductive sheets arranged opposite each other, wherein each of the conductive sheets comprises one or more main bodies and a pin, each of the one or more main bodies comprises a first end and a second end, the first end is connected to the connection part and the second end is connected to the pin, an accommodating space is defined by the connection part and the main body of each of the conductive sheets opposite each other,
wherein in a mounting direction of the winding member, a height difference between the second end and the connection part is greater than or equal to zero, a total number of the one or more connection parts is same as a total number of the one or more main bodies of each of the conductive sheets, and the total number of the one or more connection parts is N, and wherein N is a positive integer; and
two magnetic cores, opposite each other,
wherein each of the magnetic cores comprises a cover plate, a winding post and a common post, wherein both an end of the winding post and an end of the common post are connected to the cover plate, the winding post is arranged within an accommodating channel, the accommodating channel is formed by two mounting through-holes penetrating through two of the main bodies opposite to each other and respectively disposed at different ones of the two conductive sheets, and the mounting through-holes, the accommodating channel and the winding post are aligned each other, and wherein the number of the winding posts is N and the number of the common posts is greater than or equal to zero.

11. The magnetic assembly according to claim 10, wherein the first winding is a primary winding, the second winding is a secondary winding, and the secondary winding has a disk coil structure.

12. The magnetic assembly according to claim 11, wherein the side wall of the cover plate is provided with a heat dissipation groove penetrating through the cover plate in a thickness direction of the cover plate.

13. The magnetic assembly according to claim 10, wherein the first winding is the secondary winding, the second winding is the primary winding, and the primary winding has the disk coil structure.

14. The magnetic assembly according to claim 13, wherein the side wall of the cover plate is provided with a heat dissipation groove penetrating through the cover plate in a thickness direction of the cover plate.

15. The magnetic assembly according to claim 10, wherein the connection part comprises a first connection part and a second connection part, the first end of the main body is connected to the second connection part through the first connection part, and a height difference between the second end of the main body and the second connection part is greater than or equal to zero in the mounting direction of the winding member.

16. The magnetic assembly according to claim 10, wherein the pin comprises one or more first pins and one or more second pins, a total number of the one or more first pins is two, and a total number of the one or more second pins is N−1, and wherein the second pin is formed by connecting the pin connected to the second end of each of the one or more main body and the pin connected to the second end of other one of the one or more main body adjacent to the each of the one or more main body.

17. The magnetic assembly according to claim 16, wherein N=1, each of the one or more first pins are connected to the second end of each of two ones of the one or more main bodies of each of the conductive sheets and the one or more first pins are located at both sides of the connection part, respectively, and a current flowing through one of the one or more main bodies has a same direction as a current flowing through other one of the one or more main bodies.

18. The magnetic assembly according to claim 16, wherein N≥2, for two adjacent main bodies of the one or more main bodies of each of the conductive sheets, a current flowing through one of the two adjacent main bodies has an opposite direction with a current flowing through other one of the two adjacent main bodies, and wherein for two main bodies respectively at the two conductive sheets and opposite to each other, a current flowing through one of the two main bodies has a same direction as a current flowing through other one of the two main bodies.

19. A power supply, comprising: a circuit board and the magnetic assembly according to claim 11, wherein the magnetic assembly is in communication with the circuit board through the pin.
